(19) United States
(12) Patent Application Publication
(10) Pub. No.: US 2021/0224940 A1
(43) Pub. Date: Jul. 22, 2021

(54) METHODS AND SYSTEMS FOR FACILITATING MANAGEMENT OF A VIOLENT SITUATION OCCURRING IN A LOCATION

(71) Applicants: Aaron George, Austin, TX (US); Nirmala George, Austin, TX (US); Raghunathan George, Austin, TX (US)

(72) Inventors: Aaron George, Austin, TX (US); Nirmala George, Austin, TX (US); Raghunathan George, Austin, TX (US)

(21) Appl. No.: 17/153,683

(22) Filed: Jan. 20, 2021

Related U.S. Application Data
(60) Provisional application No. 62/963,434, filed on Jan. 20, 2020.

(51) Int. Cl. G06Q 50/26; G06N 20/00; G08B 25/00; G08B 21/02

(52) U.S. Cl. CPC G06Q 50/265; G08B 21/02; G08B 25/00; G06N 20/00

(57) ABSTRACT

Disclosed herein is a method for facilitating management of a violent situation occurring in a location. Accordingly, the method may include receiving, using a communication device, environment data from an environment sensor. Further, the environment sensor may be configured for capturing the environment data of a location. Further, the method may include analyzing, using a processing device, the environment data using an artificial intelligence model. Further, the method may include determining, using the processing device, an identification of the violent situation in the environment data based on the analyzing. Further, the method may include generating, using the processing device, an alert based on the identification of the violent situation. Further, the method may include transmitting, using the communication device, the alert to a device associated with an authority. Further, the method may include storing, using a storage device, the artificial intelligence model.

The current application claims a priority to the U.S. Provisional Patent application Ser. No. 62/963,434 filed on Jan. 20, 2020.

### FIELD OF THE INVENTION

Generally, the present disclosure relates to the field of data processing. More specifically, the present disclosure relates to methods and systems for facilitating management of a violent situation occurring in a location.

### BACKGROUND OF THE INVENTION

Bullying-related violence is prevalent in schools. Workplace violence occasionally shows up in the news. Further, workplace violence may be an act of abusive behavior, assaulting, threatening an individual of an individual by a second individual. Often, violence affects the individual emotionally and professionally. There are also other violent situations that result in injuries or even death.

Therefore, there is a need for improved methods and systems for facilitating management of a violent situation occurring in a location that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating management of a violent situation occurring in a location, in accordance with some embodiments. Accordingly, the method may include receiving, using a communication device, at least one environment data from at least one environment sensor. Further, the at least one environment sensor may be configured for capturing the at least one environment data of at least one location.

Further, the method may include analyzing, using a processing device, the at least one environment data using an artificial intelligence model. Further, the artificial intelligence model may be configured for predicting the violent situation occurring in the at least one location. Further, the method may include determining, using the processing device, an identification of the violent situation in the at least one environment data based on the analyzing. Further, the method may include generating, using the processing device, at least one alert based on the identification of the violent situation. Further, the method may include transmitting, using the communication device, the at least one alert to at least one device associated with at least one authority. Further, the method may include storing, using a storage device, the artificial intelligence model.

Further, disclosed herein is a method for facilitating management of a violent situation occurring in a location, in accordance with some embodiments. Accordingly, the method may include receiving, using a communication device, at least one environment data from at least one environment sensor. Further, the at least one environment sensor may be configured for capturing the at least one environment data of at least one location. Further, the method may include analyzing, using a processing device, the at least one environment data using an artificial intelligence model. Further, the artificial intelligence model may be configured for predicting the violent situation occurring in the at least one location. Further, the violent situation may include a bullying incident. Further, the bullying incident may include at least one abusive behavior of at least one first individual towards at least one second individual. Further, the method may include determining, using the processing device, an identification of the violent situation in the at least one environment data based on the analyzing. Further, the method may include generating, using the processing device, at least one alert based on the identification of the violent situation. Further, the method may include transmitting, using the communication device, the at least one alert to at least one device associated with at least one authority. Further, the method may include storing, using a storage device, the artificial intelligence model.

Further disclosed herein is a system for facilitating management of a violent situation occurring in a location, in accordance with some embodiments. Accordingly, the system may include a communication device configured for receiving at least one environment data from at least one environment sensor. Further, the at least one environment sensor may be configured for capturing the at least one environment data of at least one location. Further, the communication device may be configured for transmitting at least one alert to at least one device associated with at least one authority. Further, the system may include a processing device communicatively coupled with the communication device. Further, the processing device may be configured for analyzing the at least one environment data using an artificial intelligence model. Further, the artificial intelligence model may be configured for predicting the violent situation occurring in the at least one location. Further, the processing device may be configured for determining an identification of the violent situation in the at least one environment data based on the analyzing. Further, the processing device may be configured for generating the at least one alert based on the identification of the violent situation. Further, the system may include a storage device communicatively coupled with the processing device. Further, the storage device may be configured for storing the artificial intelligence model.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating management of a violent situation occurring in a location, in accordance with some embodiments.

FIG. 3 is a flowchart of a method for facilitating management of a violent situation occurring in a location, in accordance with some embodiments.

FIG. 4 is a flowchart of a method for identifying the artificial intelligence model for facilitating the management of the violent situation, in accordance with some embodiments.

FIG. 5 is a flowchart of a method for facilitating management of a violent situation occurring in a location, in accordance with some embodiments.

FIG. 6 is a flowchart of a method for identifying the artificial intelligence model for facilitating the management of the violent situation, in accordance with some embodiments.

FIG. 7 is a flow diagram of a method for facilitating management of a violent situation occurring in a location, in accordance with some embodiments.

FIG. 8 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating predicting of a violent situation, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating management of a violent situation occurring in a location. Further, the disclosed system may be configured for detecting violence. Further, the disclosed system may be configured for continuously training models, capturing audio streams, predicting violent situations, and sending out multi-channel alerts. Further, the disclosed system may include two subsystems: a training subsystem and a prediction subsystem. Further, the training Subsystem may be built on powerful computers with a Graphical Processing Unit. The Prediction subsystem may be built on a single-board computer with a powerful microphone array and a smartphone with internet and cellular connectivity, to constantly capture audio stream and predict violent situations. Further, a program running on the

Training Subsystem uses Artificial Intelligence/Machine Learning/Deep Learning (AI/ML/DL) algorithms on a large sound dataset to produce at least one model for prediction. After a set of successful training sessions, a best AI/ML/DL model (or champion model) of the at least one model is selected based on the training performance. Further, programs running on the Prediction Subsystem may capture audio continuously, use the champion model (or latest champion model) for real-time prediction of violence, and alert authorities and initiating alarms. The Prediction Subsystem feeds back any positively identified violent situations to the Training Subsystem for continuous learning. In addition, the sound dataset may be continually expanded as the Training Subsystem continuously learns. The Training Subsystem may push the champion model to a central Model Store. The Prediction Subsystem continuously syncs with the central model store for the champion model.

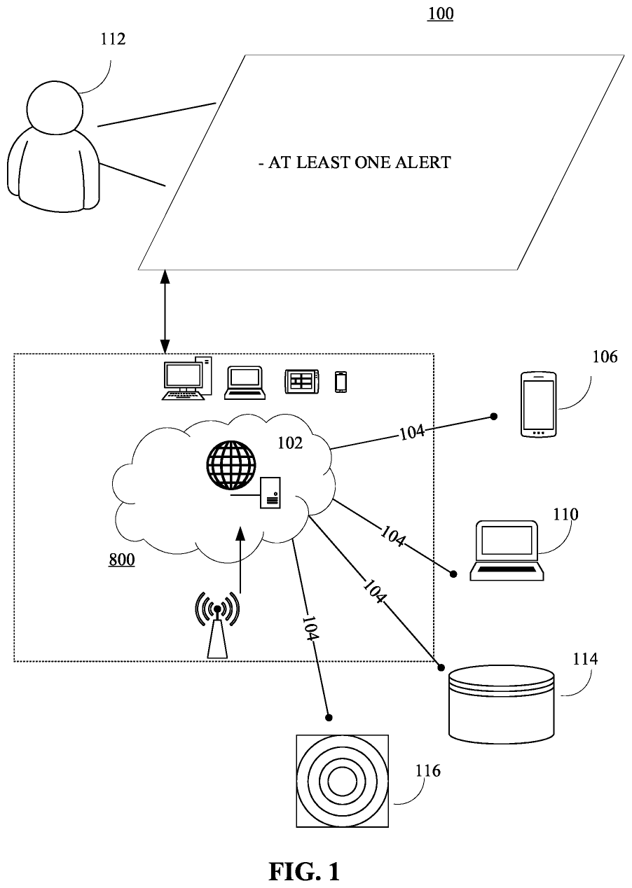

Referring now to figures, FIG. 1 is an illustration of an online platform 100 consistent with various embodiments of the present disclosure. By way of non-limiting example, the online platform 100 to facilitate management of a violent situation occurring in a location may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 800.

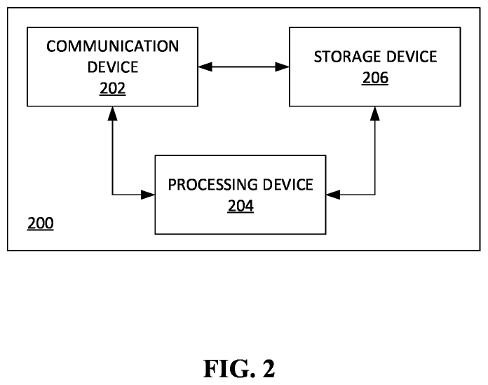

FIG. 2 is a block diagram of a system 200 for facilitating management of a violent situation occurring in a location, in accordance with some embodiments. Accordingly, the system 200 may include a communication device 202 configured for receiving at least one environment data from at least one environment sensor. Further, the at least one environment sensor may be configured for capturing the at least one environment data of at least one location. Further, the communication device 202 may be configured for transmitting at least one alert to at least one device associated with at least one authority. Further, the at least one authority may be associated with the at least one location. Further, the at least one authority may include a teacher, a supervisor, a guard, a policeman, etc. Further, the at least one location may include a school, a workplace, etc. Further, the at least one environment data may include an audio stream, a visual stream, an audio-visual stream, etc. Further, the at least one device may include a computing device such as a smartphone, a smartwatch, a tablet, a laptop, a desktop, etc.

Further, the system 200 may include a processing device 204 communicatively coupled with the communication device 202. Further, the processing device 204 may be configured for analyzing the at least one environment data using an artificial intelligence model. Further, the artificial intelligence model may be configured for predicting the violent situation occurring in the at least one location. Further, the processing device 204 may be configured for determining an identification of the violent situation in the at least one environment data based on the analyzing. Further, the processing device 204 may be configured for generating the at least one alert based on the identification of the violent situation.

Further, the system 200 may include a storage device 206 communicatively coupled with the processing device 204. Further, the storage device 206 may be configured for storing the artificial intelligence model.

Further, in some embodiments, the storage device 206 may be configured for retrieving a plurality of historical environment data. Further, the plurality of historical environment data may include an audio stream, a visual stream, an audio-visual stream, etc. Further, the processing device 204 may be configured for analyzing the plurality of historical environment data using a plurality of artificial intelligence algorithms. Further, the processing device 204 may be configured for generating a plurality of artificial intelligence models based on the analyzing of the plurality of historical environment data Further, the processing device 204 may be configured for training the plurality of artificial intelligence models using the plurality of historical environment data. Further, the processing device 204 may be configured for determining at least one training performance parameter of the plurality of artificial intelligence models after the training. Further, the processing device 204 may be configured for identifying the artificial intelligence model of the plurality of artificial intelligence models based on the determining of the at least one training performance parameter. Further, the analyzing of the at least one environment data using the artificial intelligence model may be based on the identifying of the artificial intelligence model.

Further, in some embodiments, the indication may include a positive indication and a negative indication. Further, the storage device 206 may be further configured for storing the at least one environment data based on the positive indication of the violent situation. Further, the plurality of environment data may include the at least one environment data.

Further, in some embodiments, the violent situation may include a bullying incident. Further, the bullying incident may include at least one abusive behavior of at least one first individual towards at least one second individual.

Further, in some embodiments, the violent situation may include a harassing incident. Further, the harassing incident may include at least one offensive behavior of at least one first individual towards at least one second individual.

Further, in some embodiments, the communication device 202 may be configured for transmitting the at least one alert to at least one alarm device. Further, the at least one alarm device may be configured for generating an alarm based on the at least one alert. Further, the alarm prevents an escalation of the violent situation.

Further, in some embodiments, the indication may include a positive indication and a negative indication. Further, the generating of the at least one alert may be based on the positive indication of the violent situation occurring in the at least one location.

Further, in some embodiments, the at least one environment sensor may include at least one microphone. Further, the at least one microphone may be disposed in the at least one location. Further, the at least one environment sensor data may include at least one audio stream. Further, the at least one microphone may be configured for capturing the at least one audio stream from the at least one location.

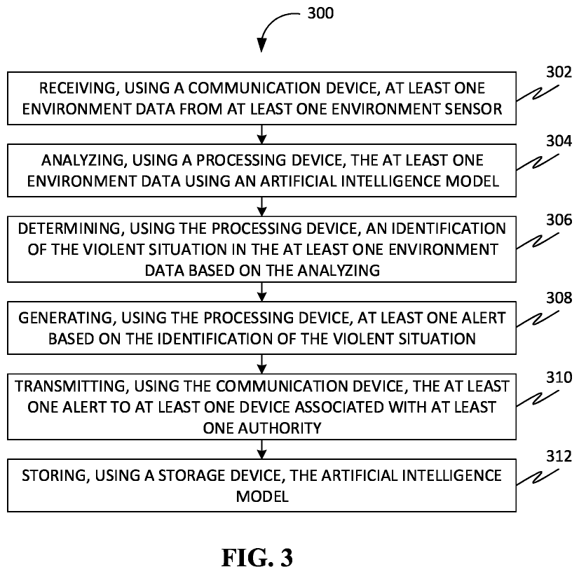

FIG. 3 is a flowchart of a method 300 for facilitating management of a violent situation occurring in a location, in accordance with some embodiments. Accordingly, at 302, the method 300 may include receiving, using a communication device, at least one environment data from at least one environment sensor. Further, the at least one environment sensor may be configured for capturing the at least one environment data of at least one location. Further, the at least one location may include a school, a workplace, etc. Further, the at least one environment data may include an audio stream, a visual stream, an audio-visual stream, etc.

Further, at 304, the method 300 may include analyzing, using a processing device, the at least one environment data using an artificial intelligence model. Further, the artificial intelligence model may be configured for predicting the violent situation occurring in the at least one location.

Further, at 306, the method 300 may include determining, using the processing device, an identification of the violent situation in the at least one environment data based on the analyzing.

Further, at 308, the method 300 may include generating, using the processing device, at least one alert based on the identification of the violent situation.

Further, at 310, the method 300 may include transmitting, using the communication device, the at least one alert to at least one device associated with at least one authority. Further, the at least one authority may be associated with the at least one location. Further, the at least one authority may include a teacher, a supervisor, a guard, a policeman, etc. Further, the at least one device may include a computing device such as a smartphone, a smartwatch, a tablet, a laptop, a desktop, etc.

Further, at 312, the method 300 may include storing, using a storage device, the artificial intelligence model.

Further, in some embodiments, the violent situation may include a bullying incident. Further, the bullying incident may include at least one abusive behavior of at least one first individual towards at least one second individual.

Further, in some embodiments, the violent situation may include a harassing incident. Further, the harassing incident may include at least one offensive behavior of at least one first individual towards at least one second individual.

In further embodiments, the method 300 may include transmitting, using the communication device, the at least one alert to at least one alarm device. Further, the at least one alarm device may be configured for generating an alarm based on the at least one alert. Further, the alarm prevents an escalation of the violent situation.

Further, in some embodiments, the indication may include a positive indication and a negative indication. Further, the generating of the at least one alert may be based on the positive indication of the violent situation occurring in the at least one location.

Further, in some embodiments, the at least one environment sensor may include at least one microphone. Further, the at least one microphone may be disposed in the at least one location. Further, the at least one environment sensor data may include at least one audio stream. Further, the at least one microphone may be configured for capturing the at least one audio stream from the at least one location.

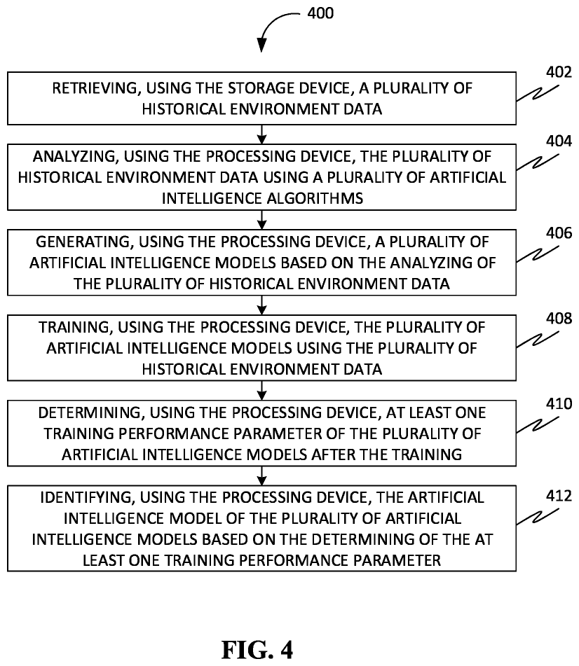

FIG. 4 is a flowchart of a method 400 for identifying the artificial intelligence model for facilitating the management of the violent situation, in accordance with some embodiments. Accordingly, at 402, the method 400 may include retrieving, using the storage device, a plurality of historical environment data. Further, the plurality of historical environment data may include an audio stream, a visual stream, an audio-visual stream, etc.

Further, at 404, the method 400 may include analyzing, using the processing device, the plurality of historical environment data using a plurality of artificial intelligence algorithms.

Further, at 406, the method 400 may include generating, using the processing device, a plurality of artificial intelligence models based on the analyzing of the plurality of historical environment data.

Further, at 408, the method 400 may include training, using the processing device, the plurality of artificial intelligence models using the plurality of historical environment data.

Further, at 410, the method 400 may include determining, using the processing device, at least one training performance parameter of the plurality of artificial intelligence models after the training.

Further, at 412, the method 400 may include identifying, using the processing device, the artificial intelligence model of the plurality of artificial intelligence models based on the determining of the at least one training performance parameter. Further, the analyzing of the at least one environment data using the artificial intelligence model may be based on the identifying of the artificial intelligence model.

Further, in some embodiments, the indication may include a positive indication and a negative indication. Further, the method 400 may include storing, using the storage device, the at least one environment data based on the positive indication of the violent situation. Further, the plurality of environment data may include the at least one environment data.

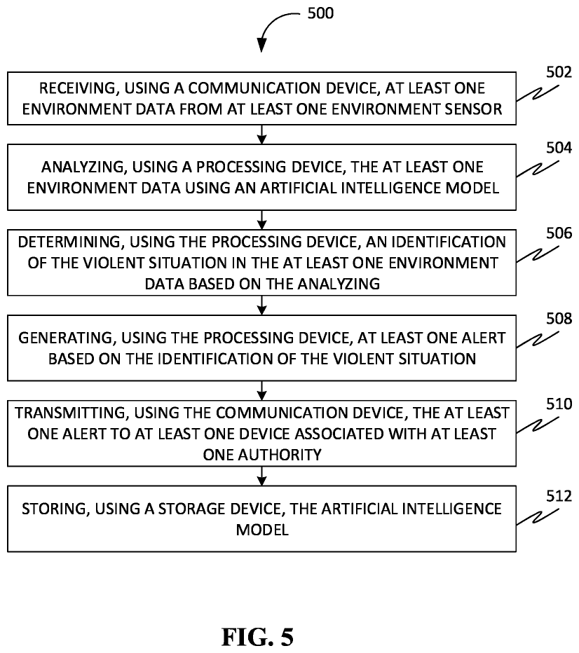

FIG. 5 is a flowchart of a method 500 for facilitating management of a violent situation occurring in a location, in accordance with some embodiments. Accordingly, at 502, the method 500 may include receiving, using a communication device, at least one environment data from at least one environment sensor. Further, the at least one environment sensor may be configured for capturing the at least one environment data of at least one location. Further, the at least one location may include a school, a workplace, etc. Further, the at least one environment data may include an audio stream, a visual stream, an audio-visual stream, etc.

Further, at 504, the method 500 may include analyzing, using a processing device, the at least one environment data using an artificial intelligence model. Further, the artificial intelligence model may be configured for predicting the violent situation occurring in the at least one location. Further, the violent situation may include a bullying incident. Further, the bullying incident may include at least one abusive behavior of at least one first individual towards at least one second individual.

Further, at 506, the method 500 may include determining, using the processing device, an identification of the violent situation in the at least one environment data based on the analyzing.

Further, at 508, the method 500 may include generating, using the processing device, at least one alert based on the identification of the violent situation.

Further, at 510, the method 500 may include transmitting, using the communication device, the at least one alert to at least one device associated with at least one authority.

Further, at 512, the method 500 may include storing, using a storage device, the artificial intelligence model.

In further embodiments, the method 500 may include transmitting, using the communication device, the at least one alert to at least one alarm device. Further, the at least one alarm device may be configured for generating an alarm based on the at least one alert. Further, the alarm prevents an escalation of the violent situation.

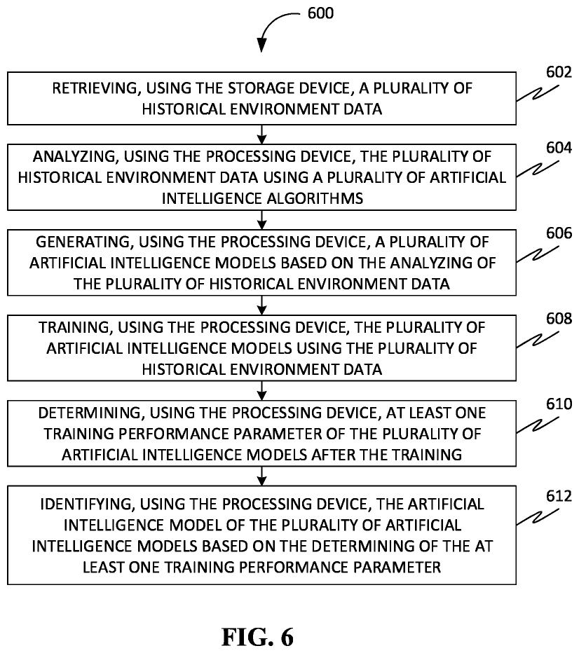

FIG. 6 is a flowchart of a method 600 for identifying the artificial intelligence model for facilitating the management of the violent situation, in accordance with some embodiments. Accordingly, at 602, the method 600 may include retrieving, using the storage device, a plurality of historical environment data. Further, the plurality of historical environment data may include an audio stream, a visual stream, an audio-visual stream, etc.

Further, at 604, the method 600 may include analyzing, using the processing device, the plurality of historical environment data using a plurality of artificial intelligence algorithms.

Further, at 606, the method 600 may include generating, using the processing device, a plurality of artificial intelligence models based on the analyzing of the plurality of historical environment data.

Further, at 608, the method 600 may include training, using the processing device, the plurality of artificial intelligence models using the plurality of historical environment data.

Further, at 610, the method 600 may include determining, using the processing device, at least one training performance parameter of the plurality of artificial intelligence models after the training.

Further, at 612, the method 600 may include identifying, using the processing device, the artificial intelligence model of the plurality of artificial intelligence models based on the determining of the at least one training performance parameter. Further, the analyzing of the at least one environment data using the artificial intelligence model may be based on the identifying of the artificial intelligence model.

Further, in some embodiments, the indication may include a positive indication and a negative indication. Further, the method 600 further may include storing, using the storage device, the at least one environment data based on the positive indication of the violent situation. Further, the plurality of environment data may include the at least one environment data.

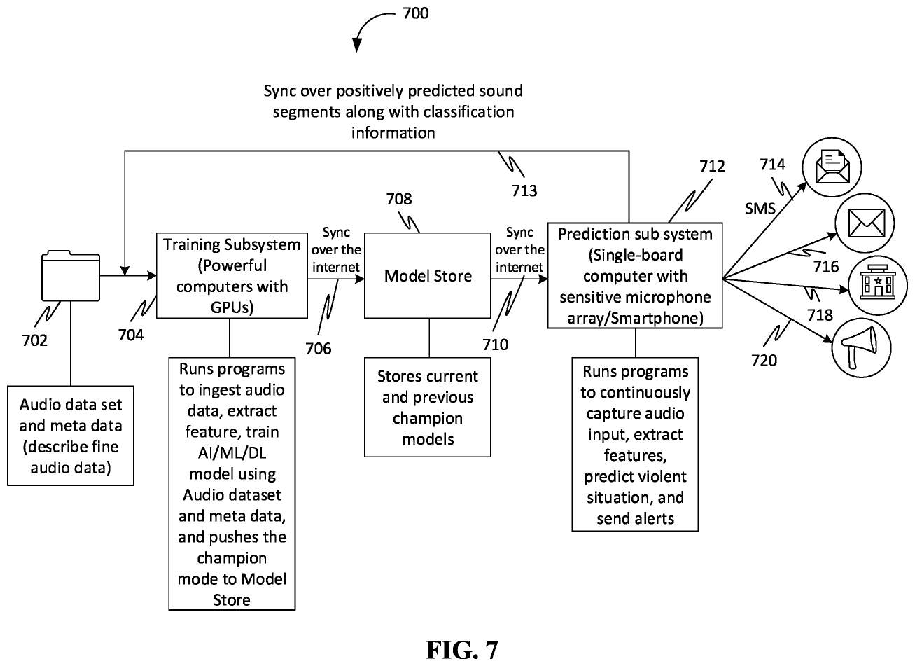

FIG. 7 is a flow diagram of a method 700 for facilitating management of a violent situation occurring in a location, in accordance with some embodiments. Accordingly, at 702, the method 700 may include audio dataset and metadata. Further, at 704, the method 700 may include a training subsystem configured for running programs to ingest the audio dataset, extract features, train AI/ML/DL model using the audio dataset and the metadata, and pushes a champion model to a model store. Further, the training system may include powerful computers with GPUs. Further, at 706, the method 700 may include syncing over a communication network (such as the internet). Further, at 708, the method 700 may include storing the champion model and previous champion models to a model store. Further, at 710, the method 700 may include syncing over the communication network (such as the internet). Further, at 712, the method 700 may include a prediction subsystem configured for running programs to continuously capturing audio input, extracting features, predicting violent situations, and sending alerts. Further, the prediction subsystem may include a single board computer with a sensitive microphone array/smartphone. Further, at 713, the method 700 may include syncing over positively predicted sound segments along with classification information. Further, at 714, the method 700 may include sending SMS. Further, at 716, the method 700 may include sending an email. Further, at 718, the method 700 may include notifying an emergency authority (such as notifying 911). Further, at 720, the method 700 may include local and remote audio and visual announcements.

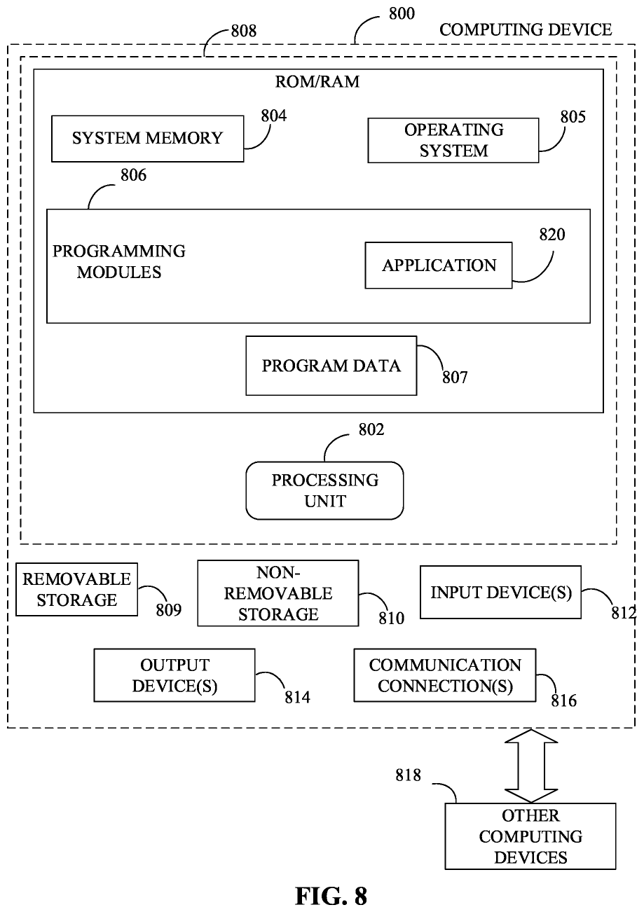

With reference to FIG. 8, a system consistent with an embodiment of the disclosure may include a computing device or cloud service, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800′s operation. In one embodiment, programming modules 806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and non-volatile, removable and non-removable media implemented in any method or technology for storage of information, such as computer-readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, a location sensor, a camera, a biometric sensor, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., application 820) may perform processes including, for example, one or more stages of methods, algorithms, systems, applications, servers, databases as described above. The aforementioned process is an example, and processing unit 802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM.

Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for facilitating management of a violent situation occurring in a location, the method comprising:
receiving, using a communication device, at least one environment data from at least one environment sensor, wherein the at least one environment sensor is configured for capturing the at least one environment data of at least one location;
analyzing, using a processing device, the at least one environment data using an artificial intelligence model, wherein the artificial intelligence model is configured for predicting the violent situation occurring in the at least one location;
determining, using the processing device, an identification of the violent situation in the at least one environment data based on the analyzing;
generating, using the processing device, at least one alert based on the identification of the violent situation;
transmitting, using the communication device, the at least one alert to at least one device associated with at least one authority; and
storing, using a storage device, the artificial intelligence model.

2. The method of claim 1 further comprising:
retrieving, using the storage device, a plurality of historical environment data;
analyzing, using the processing device, the plurality of historical environment data using a plurality of artificial intelligence algorithms;
generating, using the processing device, a plurality of artificial intelligence models based on the analyzing of the plurality of historical environment data;
training, using the processing device, the plurality of artificial intelligence models using the plurality of historical environment data;
determining, using the processing device, at least one training performance parameter of the plurality of artificial intelligence models after the training; and
identifying, using the processing device, the artificial intelligence model of the plurality of artificial intelligence models based on the determining of the at least one training performance parameter, wherein the analyzing of the at least one environment data using the artificial intelligence model is based on the identifying of the artificial intelligence model.

3. The method of claim 2, wherein the indication comprises a positive indication and a negative indication, wherein the method further comprising storing, using the storage device, the at least one environment data based on the positive indication of the violent situation, wherein the plurality of environment data comprises the at least one environment data.

4. The method of claim 1, wherein the violent situation comprises a bullying incident, wherein the bullying incident comprises at least one abusive behavior of at least one first individual towards at least one second individual.

5. The method of claim 1, wherein the violent situation comprises a harassing incident, wherein the harassing incident comprises at least one offensive behavior of at least one first individual towards at least one second individual.

6. The method of claim 1 further comprising transmitting, using the communication device, the at least one alert to at least one alarm device, wherein the at least one alarm device is configured for generating an alarm based on the at least one alert, wherein the alarm prevents an escalation of the violent situation.

7. The method of claim 1, wherein the indication comprises a positive indication and a negative indication, wherein the generating of the at least one alert is further based on the positive indication of the violent situation occurring in the at least one location.

8. The method of claim 1, wherein the at least one environment sensor comprises at least one microphone, wherein the at least one microphone is disposed in the at least one location, wherein the at least one environment sensor data comprises at least one audio stream, wherein the at least one microphone is configured for capturing the at least one audio stream from the at least one location.

9. A method for facilitating management of a violent situation occurring in a location, the method comprising:
receiving, using a communication device, at least one environment data from at least one environment sensor, wherein the at least one environment sensor is configured for capturing the at least one environment data of at least one location;
analyzing, using a processing device, the at least one environment data using an artificial intelligence model, wherein the artificial intelligence model is configured for predicting the violent situation occurring in the at least one location, wherein the violent situation comprises a bullying incident, wherein the bullying incident comprises at least one abusive behavior of at least one first individual towards at least one second individual;
determining, using the processing device, an identification of the violent situation in the at least one environment data based on the analyzing;
generating, using the processing device, at least one alert based on the identification of the violent situation;
transmitting, using the communication device, the at least one alert to at least one device associated with at least one authority; and
storing, using a storage device, the artificial intelligence model.

10. The method of claim 9 further comprising:
retrieving, using the storage device, a plurality of historical environment data;
analyzing, using the processing device, the plurality of historical environment data using a plurality of artificial intelligence algorithms;
generating, using the processing device, a plurality of artificial intelligence models based on the analyzing of the plurality of historical environment data;
training, using the processing device, the plurality of artificial intelligence models using the plurality of historical environment data;
determining, using the processing device, at least one training performance parameter of the plurality of artificial intelligence models after the training; and
identifying, using the processing device, the artificial intelligence model of the plurality of artificial intelligence models based on the determining of the at least one training performance parameter, wherein the analyzing of the at least one environment data using the artificial intelligence model is based on the identifying of the artificial intelligence model.

11. The method of claim 10, wherein the indication comprises a positive indication and a negative indication, wherein the method further comprising storing, using the storage device, the at least one environment data based on the positive indication of the violent situation, wherein the plurality of environment data comprises the at least one environment data.

12. The method of claim 9 further comprising transmitting, using the communication device, the at least one alert to at least one alarm device, wherein the at least one alarm device is configured for generating an alarm based on the at least one alert, wherein the alarm prevents an escalation of the violent situation.

13. A system for facilitating management of a violent situation occurring in a location, the system comprising:
a communication device configured for:
receiving at least one environment data from at least one environment sensor, wherein the at least one environment sensor is configured for capturing the at least one environment data of at least one location; and
transmitting at least one alert to at least one device associated with at least one authority;
a processing device communicatively coupled with the communication device, wherein the processing device is configured for:
analyzing the at least one environment data using an artificial intelligence model, wherein the artificial intelligence model is configured for predicting the violent situation occurring in the at least one location;
determining an identification of the violent situation in the at least one environment data based on the analyzing; and
generating the at least one alert based on the identification of the violent situation; and
a storage device communicatively coupled with the processing device, wherein the storage device is configured for storing the artificial intelligence model.

14. The system of claim 13, wherein the storage device is further configured for retrieving a plurality of historical environment data, wherein the processing device is further configured for:
analyzing the plurality of historical environment data using a plurality of artificial intelligence algorithms;
generating a plurality of artificial intelligence models based on the analyzing of the plurality of historical environment data;
training the plurality of artificial intelligence models using the plurality of historical environment data;
determining at least one training performance parameter of the plurality of artificial intelligence models after the training; and
identifying the artificial intelligence model of the plurality of artificial intelligence models based on the determining of the at least one training performance parameter, wherein the analyzing of the at least one environment data using the artificial intelligence model is based on the identifying of the artificial intelligence model.

15. The system of claim 14, wherein the indication comprises a positive indication and a negative indication, wherein the storage device is further configured for storing the at least one environment data based on the positive indication of the violent situation, wherein the plurality of environment data comprises the at least one environment data.

16. The system of claim 13, wherein the violent situation comprises a bullying incident, wherein the bullying incident comprises at least one abusive behavior of at least one first individual towards at least one second individual.

17. The system of claim 13, wherein the violent situation comprises a harassing incident, wherein the harassing incident comprises at least one offensive behavior of at least one first individual towards at least one second individual.

18. The system of claim 13, wherein the communication device is further configured for transmitting the at least one alert to at least one alarm device, wherein the at least one alarm device is configured for generating an alarm based on the at least one alert, wherein the alarm prevents an escalation of the violent situation.

19. The system of claim 13, wherein the indication comprises a positive indication and a negative indication, wherein the generating of the at least one alert is further based on the positive indication of the violent situation occurring in the at least one location.

20. The system of claim 13, wherein the at least one environment sensor comprises at least one microphone, wherein the at least one microphone is disposed in the at least one location, wherein the at least one environment sensor data comprises at least one audio stream, wherein the at least one microphone is configured for capturing the at least one audio stream from the at least one location.
